(19) United States
(12) Patent Application Publication
(10) Pub. No.: US 2009/0306467 A1
(43) Pub. Date: Dec. 10, 2009

(54) METHOD TO PRESERVE AND RESTORE ERECTILE FUNCTION

(75) Inventors: Jens Sonksen, Holte (DK); Mikkel Fode, Aarhus N. (DK)

Correspondence Address: DARBY & DARBY P.C., P.O. BOX 770, Church Street Station, New York, NY, 10008-0770, US

(73) Assignee: MULTICEPT A/S, Albertslund (DK)

(21) Appl. No.: 12/478,153

(22) Filed: Jun. 4, 2009

Related U.S. Application Data
(60) Provisional application No. 61/058,608, filed on Jun. 4, 2008.

(51) Int. Cl. A61H 19/00

(52) U.S. Cl. 600/38; 601/46

(57) ABSTRACT

Disclosed herein are a method and apparatus for preservation and restoration of erectile function.

### TECHNICAL FIELD

This invention relates to the preservation and restoration of erectile function.

### BACKGROUND OF THE INVENTION

Erectile dysfunction describes the condition where a man is unable to develop or maintain an erection of the penis. The condition is distressing and can significantly diminish the quality of life for those men affected and for their partners and it is estimated that around 18 million people in the US alone suffers from erectile dysfunction.

After a nerve sparing radical prostatectomy a substantial part of the patients will develop erectile dysfunction (72% after 5 years). As this side effect significantly diminishes the quality of life for the patient, the risk of this side effect causes many patients to postpone the decision to have an operation.

Today erectile dysfunction is treated by phophodiesterase-5 inhibitors, vacuum erection devices, intracavernous injections or intraurethral applications of prostaglandins and penile implants with varying results.

### SUMMARY OF THE INVENTION

The present invention concerns a method for preservation and restoration of erectile function, wherein human beings are treated by external vibratory stimulation of the frenulum penis.

By applying vibratory stimulation on the frenulum of the penis it is possible to stimulate the afferent fibers of the dorsal nerve of the penis. These fibers course trough the pudendal nerve to reach the spinal cord at the level of S2-S4 initiating an efferent reflex signal back to the penile tissue. The efferents found on this level include both the somatic fibers of the pudendal nerve and the parasympathetic fibers running via the pelvic nerve and pelvic plexus to the penile cavernous nerve.

In erectile tissue parasympathetic nerves release acetylcholine (ACh) and nitric oxide (NO). The ACh works by inducing NO production in endothelial cells of the blood vessels through the activation of G-protein coupled muscarinic receptors. Both endothelial NO and nerve derived NO then diffuse to the vascular smooth muscle cells of the cavernous tissue. Here guanylyl cyclase is stimulated to produce cyclic guanosine monophosphate (GMP) which in turn causes the smooth muscle cells to relax. This equals vasodilation and increased blood flow to the tissue. This mechanism is believed to be essential in supplying oxygen to the cavernous tissue.

Erectile function becomes impaired immediately following pelvic surgery such as radical prostatectomy, radical cystoprostatectomy (cystectomy), low anterior or abdominoperineal resections for rectal cancer, resection of retroperitoneal tumors, retroperitoneal lymph node dissection (lymphadenectomy) and it is thought to be secondary to the damage of the cavernous nerves, which is known as neuropraxia. Neuropraxia can be caused by nerve stretching, thermal damage, ischemia and local inflammatory effects associated with surgical trauma. These nerves tend to recover slowly, and it may take as long as 3 years for them to reach baseline function status. This means that the nerves will only preserve some function right after the operation, and in most cases this is not enough to secure sufficient oxygenation of the cavernous tissue. Prolonged hypoxia will induce the production of endothelin-1 and inhibit the production of prostaglandin-E1. Endothelin-1 is a constrictor of penile smooth muscle and a profibrotic peptide while prostaglandin-E1 normally functions to inhibit collagen formation. The result is cavernosal fibrosis ultimately leading to a venous leak presenting as venogenic erectile dysfunction. Also a decreased arterial inflow caused by damage of the cavernous nerves in combination with ligation of the internal pudendal arteries during the radical prostatectomy will intensify hypoxia of the cavernous tissue and ultimately lead to apoptosis or programmed cell death.

Penile vibratory stimulation induces reflex signal transduction through partially functioning nerves and will insure NO supply and thus improve blood flow and oxygenation of the cavernosal tissue following pelvic surgery such as radical prostatectomy. This will in turn reduce or prevent the development of the cavernous fibrosis and aid in maintaining the integrity of the tissue in the crucial period following the initial nerve damage. It is also believed that the nerve stimulation will improve nerve recovery ensuring that this will take place both faster and to a greater extend. Both effects makes external penile vibratory stimulation a valuable tool in preserving and restoring erectile function following radical prostatectomy or other types of pelvic surgery such as for example cystectomy due to urinary bladder cancer.

Vibrators as an aid for generating ejaculation in men are known. Since the 1980's externally vibratory stimulation of the dorsal penile nerve has been used to induce ejaculation in men with spinal cord injuries. These patients are generally not able to obtain ejaculation by sexual stimulation or masturbation. In the light of previous studies concerning the significance of the vibration amplitude in inducing reflex ejaculation with penile vibration it is now possible to reestablish the ability to ejaculate in about 80% of all men with spinal cord injuries above the level of T10. The treatment leading to ejaculation in men with spinal cord injuries comprises vibratory stimulation for one period until ejaculation takes place i.e. the vibratory stimulation is not used to treat the nerves for the purpose of increasing oxygenation of the cavernous tissue and achieving a long-term effect in respect of obtaining and maintaining an erection.

Useful vibrators are e.g. based on a loudspeaker or shaking table principle. This principle requires the use of a large magnet, and the vibrators are therefore constructed as large, heavy table models consisting of several separate units which are connected via wires. These vibrators, which are expensive to manufacture, are difficult to handle and adjust for safe and reliable treatment. Further, they are not suitable for domestic use, since they are stationary and take up relatively much space.

EP0822798B1 discloses a vibrator which can be used by men suffering from paralysis caused by e.g. a spinal injury enabling ejaculation by imparting vibrations to the penis.

U.S. Pat. No. 6,505,630B1 discloses a vibrator for use in a method for treating urinary bladder dysfunction in men or women by effective mechanical vibration or stimulation of the external genital area. By external genital area are meant clitoris and/or surroundings for women and frenulum praeputii and/or surroundings for men. The treatment is performed to ejaculation/pseudoorgasm using an average period of vibratory stimulation of one minute, the vibratory stimulation is performed twice a week or every third day or up to 6 times a day during a period of e.g. four weeks.

Neither of the publications discloses the use of a vibrator and vibratory stimulation for restoring erectile function.

There is a wish in this group of patients for the ability of vibration treating the penis in private, and accordingly there is an additional need for a vibrator which is easy to carry. Further, for several reasons, there is a need for a vibrator which can be operated by just one hand. In the first place, one hand operation is desirable, because the other hand may then be used for holding a semen collection container. Finally, one hand operation is also advantageous with respect to keeping the counterforce on the opposite side of the penis constant, which gives the best result.

Accordingly, there is a need for a vibrator which can be handled and be adjusted in a safe manner for safe and reliable treatment, and which is portable and can be employed using just one hand. The vibrator of the present invention is characterized in that said conversion element is mounted as well rotatable as slidable in said recess, said recess having a width greater than the width of the conversion element and having an extent in the width which is substantially perpendicular to the direction of the upward and downward movement of the engagement face, that the arm is in rigid connection with the engagement face, and that the housing also comprises a frequency regulating device for regulating the frequency of the upward and downward movement of the engagement face. As a result, the vibrator may be built as a particularly compact structure having a low overall height which enables it to be used for the treatment of the penis with just one hand. The structure of the amplitude regulating device ensures that the amplitude of the upward and downward movement of the engagement face may be regulated steplessly and is independent of the applied force. Finally, the amplitude regulating device is formed by just a few mechanical components (inclined shaft, conversion element and arm), which in addition to the compact structure also makes the device very reliable. In use, the engagement face of the vibrator is placed against the penis, while the vibrator is held by hand. The treatment of the penis may be effected with one hand, as the compact structure allows the patient to use the thumb of the hand as a counter rest on the opposite side of the penis. Activation of the vibrator causes the engagement face to begin to vibrate, and the rotation of the motor will be converted into an upward and downward movement of the engagement face. By regulating the frequency regulating device and the amplitude regulating device and varying the force applied by the engagement face to the body, the user himself can adapt the vibration for safe treatment.

Description of External Penile Vibratory Stimulation

External penile vibratory stimulation to restore the erectile function is normally performed daily. The center of the vibrator disc is placed on the frenulum of the penis (see FIG. 6). Stimulation at the frenulum or glans or corpus of the penis as well as the perineum is also expected to have an effect.

An optimal procedure for penile vibratory stimulation should be initiated 1 to 4 weeks before the radical prostatectomy and re-initiated within few days after the operation and continue for 1-8 weeks, normally 4-6 weeks. However, the required vibratory stimulation period can differ from person to person, and moreover depend on the type of injury received by the person concerned. Therefore, in some cases it may be necessary to stimulate for longer periods of time. But stimulation initiated only after loss of the erectile function e.g. after radical prostatectomy will also have an effect.

The daily stimulation sequence consists of periods of vibrations followed by a pause of approximately the same length as the vibration period.

Normally a sequence consisting of periods of 5-15 seconds of vibrations followed by a pause of 5-15 seconds where each sequence i.e. vibration period and pause is repeated 5-20 times is found to be effective. Normally each sequence takes 8-15 minutes.

In a procedure according to the invention the vibratory stimulation is delivered with a vibratory peak-to-peak amplitude of 1.0-3.0, normally 1.5-2.5 mm and a frequency of 80-150 Hz.

In an optimal procedure of the invention the vibratory stimulation is delivered with a vibratory peak-to-peak amplitude of 1.5-2.5, normally 2 mm and a frequency of 80-120 Hz, normally 100 Hz. However, the required vibration pattern and the necessary period of time for the action on the penis differ from person to person, and moreover depend on the type of injury received by the person concerned. Therefore, individual adaptation of the vibration pattern, namely frequency and amplitude, to a given group of patients can be necessary.

The best mode of stimulation includes peak-to-peak amplitude of 2.0 mm and a frequency of 100 Hz. However, there may be individual variation in the stimulation time, frequency and amplitude also outside these values still having an effect on the preservation and restoration of erectile function after radical prostatectomy or other types of pelvic surgery.

The mechanical vibration or stimulation can for example be performed by a vibrator source as known from international patent application no. WO 96/32916.

A physician, physiotherapist, nurse or the like can operate the vibrator source, but normally the patient himself can operate the vibrator after instruction.

### BRIEF DESCRIPTION OF THE DRAWINGS

The invention will be explained more fully below with reference to the drawing, in which

FIG. 1 is a perspective view of the vibrator,

FIG. 2 is a sectional lateral view of the vibrator,

FIG. 3 is sectional top view of the vibrator,

FIG. 4 is an end view of the vibrator along the section A-A, and

FIG. 5 is a partially sectional view of the amplitude regulating device in four positions during rotation of the motor, and

FIG. 6 shows the vibrator used with one hand where the center of the vibrator disc is placed on the frenulum penis.

### BRIEF DESCRIPTION OF THE VIBRATOR

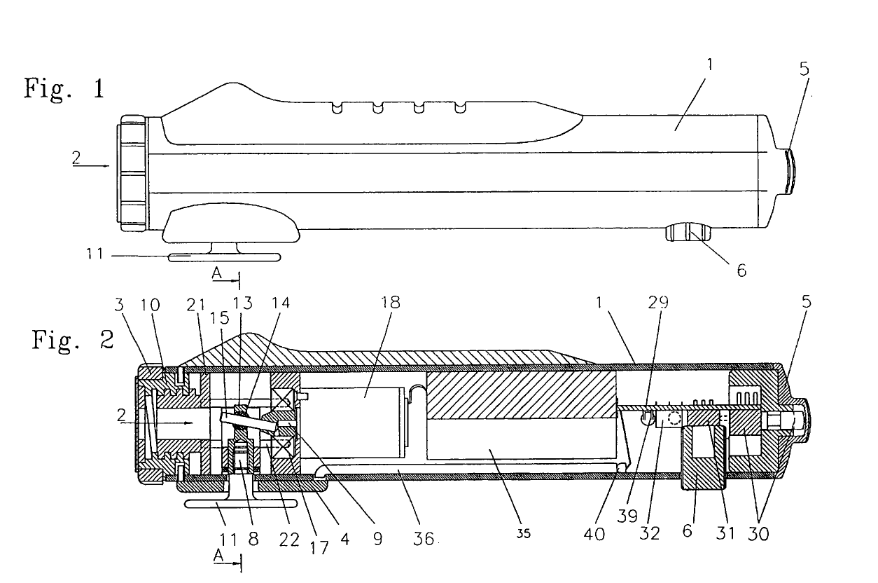

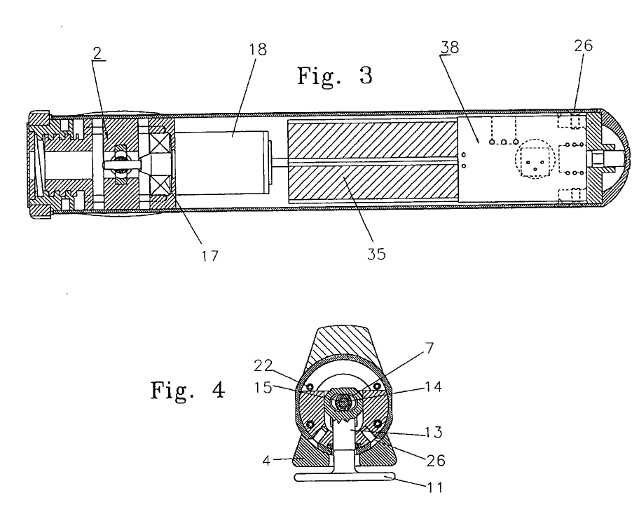

FIG. 1 shows an advantageous embodiment of the vibrator of the invention. The vibrator, which is adapted to generate ejaculation in men, comprises a housing 1 and an engagement face 11. The engagement face 11 is adapted to engage the penis externally. The housing 1 constitutes a storage unit for the technical components of the vibrator as well as a handle for the vibrator. The housing 1, see FIGS. 2 and 3, interiorly accommodates an electrically driven motor 18, which, via the motor shaft 9, drives a shaft 15 inclined with respect thereto. The motor shaft 9 is mounted in a supporting ball bearing 17.

The motor 18 is connected via wires (not shown) to an electronic unit 38 which is supplied with power by the self-supplying power unit. The electronic unit 38 is mounted on a printed circuit board 29.

In the shown embodiment, the self-supplying power unit is formed by a battery packet 35 which consists of chargeable NiCd batteries arranged side by side and in extension of each other. The use of batteries allows the vibrator to be used in all desired surroundings, including locations where there is no access to the mains supply. It is moreover ensured that the user cannot be subjected to dangerous electric shocks if the vibrator is used in moist surroundings, such as e.g. a steamy or wet bathroom.

The batteries may be charged without being removed from the vibrator, through a charger socket 32 which is provided in the side of the vibrator. A light diode 39 signals the charged state of the batteries.

The frequency regulating device is adapted to control the frequency of the vibration. This is done by regulating the voltage supply to the electrically driven motor 18, whereby the frequency, i.e. the number of the upward and downward movements of the engagement face 11 per unit of time, is regulated independently of the load. The frequency is typically regulated in the range from 0 to 200 Hz. The frequency regulating device is operated via a rubber knob 6 surrounding a potentiometer 31 which is connected to the electronic unit 38.

The housing 1 moreover comprises a mechanical amplitude regulating device 2 which is adapted to regulate the amplitude of the engagement face 11, i.e. the height of the upward and downward movement. The amplitude is typically regulated in the range from 0 to 5 mm, it being recommended to use as small amplitude as necessary to generate ejaculation. The reason is that the risk of tissue injuries increases when the amplitude is increased.

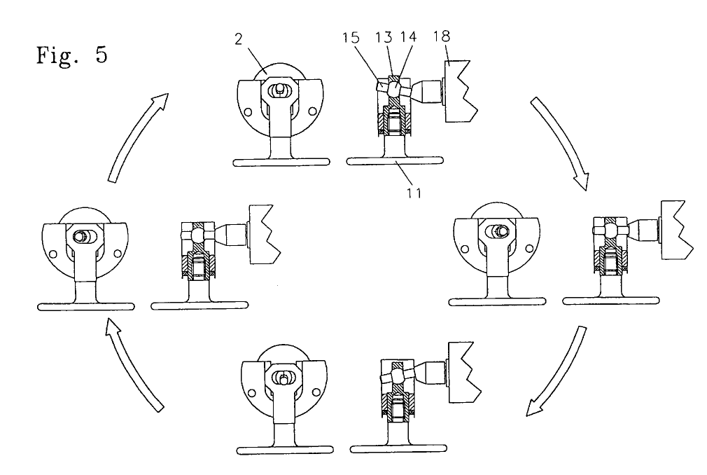

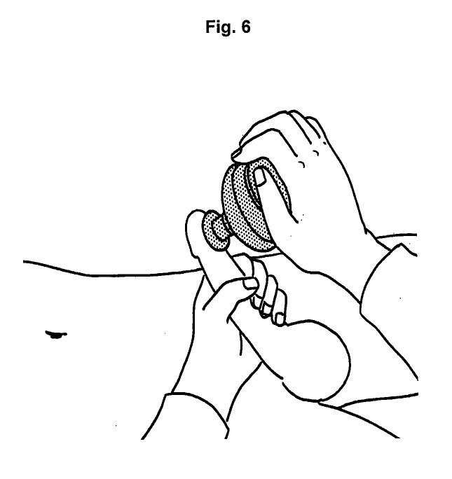

The amplitude regulating device 2 comprises an arm 13 which is formed with a horizontal recess 7, see FIG. 4. This recess 7 accommodates a ball 14 having a through bore. The bore of the ball 15 surrounds a portion of the inclined shaft 15, as is shown in FIG. 3. Thus, rotation of the motor shaft 9 and thereby also of the inclined shaft 15 causes the arm 13 to perform an upward and downward movement. This mechanism is shown in greater detail in FIG. 5, in which the amplitude regulating device 2 is shown in four different positions through a cycle of rotation. FIG. 5 shows each position partly from the end of the amplitude regulating device 2 and partly in a section through the arm 13. As the arm 13 is secured at its lower end with respect to the engagement face 11, said face will likewise perform an upward and downward movement.

The motor 18 is connected with a threaded guide 21 via four shafts 22 and is thus movable to and fro inside the housing 1. This is done by rotating an amplitude regulating knob 10 via a rubber part 3, which is arranged at the end of the housing 1, as this converts rotary movement to a linear sliding movement of the motor 18 via the threaded guide 21. The inclined shaft 15 will hereby also be moved to and fro in the ball 14. Depending on the position of the inclined shaft 15 with respect to the arm 13, the amplitude of the engagement face 11 may thus be regulated. Thus, the amplitude increases when the motor 18 is moved in a direction away from the arm 13, and correspondingly decreases when the motor 18 is moved in a direction toward the arm 13. The reason is that the shaft 15 is inclined.

The ball 14 has a smaller diameter in the direction of the bore, which appears clearly from FIG. 5. The ball may hereby easily be mounted in the recess 7 of the arm, and the ball 14 cannot drop out when the inclined shaft 15 is positioned in the bore. This provides a very simple amplitude regulating device allowing the amplitude to be regulated steplessly and to be independent of the force applied to the engagement face. Finally, the amplitude regulating device only has few mechanical components (inclined shaft, ball and arm).

The amplitude regulating knob 10 is provided thereon with a rubber part having a scale 3 for the reading of the amplitude of the vibrator.

The vibrator, which is shown in FIGS. 1-4, moreover comprises a light diode 40 and a fluorescent tube 36 which signal the user when the engagement face 11 is subjected to a force which is inexpediently great seen in relation to the ideal vibration pattern, and which also emit an increasing amount of light when the force increases. Thus, the signal is variable, and in another embodiment of the invention the light diode 40 might e.g. have three different colors, each of which emits light at a different load.

This reduces the risk of tissue injuries, one reason being that a paralyzed person who cannot feel the force on the penis is informed via the indicator that the load is inexpediently great. The inexpedient force is in the range which corresponds to a counterforce on the opposed side of the penis of about 5 to 7 N and more, but differs from person to person. The force applied is registered by the electronic unit 38, as the voltage data associated with the force are known.

The predetermined maximum value of the force corresponds to a counterforce on the other side of the penis of between about 2 and 7 N. The light diode 4C thus signals when the vibration pattern is inexpedient.

The supply of power to the motor 18 increases in steps corresponding to the load in order to maintain a predetermined frequency. If the load is increased beyond a predetermined maximum value, the necessary supply of current and voltage no longer keeps step, and the frequency of the engagement face 11 will therefore decrease. If the load is increased additionally, the vibration stops completely.

In the embodiment shown, the fluorescent tube 36 directs light from the light diode 40 to an area externally on the housing 1 which is located at the engagement face 11. At this area the housing 1 is surrounded by a transparent material 4 which causes the area around the engagement face 11 to be illuminated when the indicator is activated, i.e. when the engagement face is subjected to a force which is greater than the predetermined value.

The activation of the light diode 40 takes place in that the electronic unit 38 registers the power consumption of the motor 18. In the embodiment shown, the vibrator moreover comprises an on/off switch 30 which is provided at the opposite end of the amplitude regulating knob 10 of the vibrator. The on/off switch 30 is activated merely by pressing the end member 5 of the vibrator. The vibrator may thus be operated with just one hand, e.g. by pressing the on/off switch 30 down against a firm base.

The engagement face 11 is moreover secured to the arm 13 via threads 8 and may therefore easily be replaced by e.g. other types of engagement faces.

It is shown in FIG. 6 how the vibrator may be used for treating the penis by means of one hand. It will thus be seen that the low overall height of the vibrator, which is a consequence of the compact structure of the amplitude regulating device 2 of the invention, ensures that both the vibrator 1 and the penis 41 may be held between the thumb and the other fingers of the hand. It is hereby relatively easy to maintain a constant counterforce on the penis, which gives the best result in use. Further, the other hand is free e.g. for holding a collection container for the semen.

The individual parts of the vibrator are assembled by means of screws 26 in the embodiment shown, but might also be assembled via snap couplings or the like.

In another embodiment of the invention, the inclined shaft is formed by a bent shaft. This provides the same effect, but obviates the assembly between the motor shaft 9 and the inclined shaft 15.

Many modifications are possible without departing from the idea of the invention. In the embodiment shown, the indicator is e.g. adapted to apply a visual indication, but this indication might also be provided by e.g. a sound signal.

Further, both the frequency regulating device and the amplitude regulating device 2 may be constructed in many ways, e.g. the frequency regulation might take place mechanically, and the amplitude regulation might e.g. take place by displacing the arm 13 instead of the motor 18.

In still another embodiment, the apparatus may have a spring arranged between the housing 1 and the arm 13. Then, depending on the dimensions of the spring, the natural frequency of the system might be regulated so that it e.g. corresponds to the treatment frequency, thereby permitting the battery consumption to be reduced.

The frequency and amplitude regulating devices may likewise be regulated automatically so that: one or both of these parameters may vary in time according to a determined pattern.

The apparatus might also be provided with a counter rest which, like the engagement face of the vibrator, engages the penis, merely on its opposed side. The force applied by the engagement face to the penis might hereby be controlled by regulating the force applied by the counter rest.

Finally, the power supply might be separate from the vibrator and merely be connected to it via a wire, and optionally the motor may also be located outside the housing and be connected via a flexible shaft. The hand-operated part of the vibrator will have a considerably reduced weight in such embodiments, which may be an advantage for certain groups of patients.

### EXAMPLES

Experiments have been performed on men undergoing radical prostatectomy or other forms of pelvic surgery. The following experiments were performed by vibration with a vibrator type “Ferticare Personal Care” from the firm Multicept A/S, Albertslund, Denmark. The frequency used during the treatment was 100 Hz and the vibratory peak-to-peak amplitude was 2.0 mm.

### Experiment I

### External Penile Vibratory Stimulation Following Radical Prostatectomy in Men With Prostate Cancer

Eleven men with erectile dysfunction (complete) after prostate cancer and nerve sparing radical prostatectomy were recruited for the study. None of them were able to achieve an erection sufficient for sexual intercourse after surgery in contrast to normal erectile function before surgery.

Three months or more after the surgery, the eleven men began to perform external vibratory stimulation of the penis once daily for six weeks. The daily stimulation sequence consists of 10 seconds of vibration followed by a 10 second pause repeated 10 times.

The following observations were noted: After 6 weeks of stimulation 5 out of 11 men were able to achieve an erection sufficient for sexual intercourse.

### Experiment II

### External Penile Vibratory Stimulation Following Cystectomy in Men With Urinary Bladder Cancer

The same experiment as in experiment I was performed in 5 men with erectile dysfunction (complete) following bladder cancer and cystectomy. None of them were able to achieve an erection sufficient for sexual intercourse after surgery in contrast to normal erectile function before surgery.

The daily stimulation sequence consists of 10 seconds of vibration followed by a 10 second pause repeated 10 times.

The following observations were noted: After 6 weeks of stimulation 3 out of 5 men were able to achieve an erection sufficient for sexual intercourse.

### Conclusions of the Experiments

External penile vibratory stimulation performed once daily in men with loss of erectile function after pelvic surgery have shown effect on restoration of the penile function leading to erection sufficient for sexual intercourse.

It is expected that external penile vibratory stimulation performed before and after pelvic surgery will further enhance the possibilities of preservation and restoration of erectile function.

1. A method for preservation and restoration of erectile function wherein men are treated by external penile vibratory stimulation before and/or after pelvic surgery in daily sequences for at least 1 week.

2. A method according to claim 1 for preservation and restoration of erectile function wherein men are treated with external penile vibratory stimulation of the frenulum or glans or corpus of the penis, more specifically on the afferent fibers of the dorsal nerve of the penis.

3. A method according to claim 2 wherein a sequence consists of periods of 5-15 seconds of stimulation followed by a pause where the periods of stimulation are repeated 5-20 times.

4. A method according to claim 2, wherein men are treated with external penile vibratory stimulation with a daily stimulation sequence of 10 seconds of vibration followed by a 10 second pause repeated 10 times.

5. A method according to claim 1, wherein the vibratory stimulation is delivered with a vibratory peak-to-peak amplitude of 1.0-3.0, normally 1.5-2.5 mm and a frequency of 80-150 Hz.

6. A method according to claim 1, wherein the vibratory stimulation is delivered with a vibratory peak-to-peak amplitude of 1.5-2.5, normally 2 mm and a frequency of 80-120 Hz, normally 100 Hz.

7. A method according to claim 1, wherein penile vibratory stimulation is initiated after a procedure causing erectile dysfunction such as pelvic surgery and continued for 6 weeks from initiation.

8. A method according to claim 1, wherein penile vibratory stimulation is initiated 1 to 4 weeks before a procedure having a risk of causing erectile dysfunction such as pelvic surgery and re-initiated within few days after the procedure and continuing for 6 weeks after the procedure.

9. A method according to claim 1, wherein the vibratory stimulation is performed on a man having had pelvic surgery such as radical prostatectomy, radical cystoprostatectomy (cystectomy), low anterior or abdominoperineal resections for rectal cancer, resection of retroperitoneal tumors, retroperitoneal lymph node dissection (lymphadenectomy).
